(19) United States
(12) Patent Application Publication
(10) Pub. No.: US 2015/0138859 A1
(43) Pub. Date: May 21, 2015

(54) SYSTEM AND METHOD FOR POWER CONVERSION

(71) Applicant: General Electric Company, Schenectady, NY (US)

(72) Inventors: Rui Zhou, Niskayuna, NY (US); Luis Jose Garces, Niskayuna, NY (US); Fengfeng Tao, Clifton Park, NY (US); Maja Harfman Todorovic, Niskayuna, NY (US); Charles Michael Stephens, Pattersonville, NY (US); Lei Wang, Austin, TX (US)

(73) Assignee: General Electric Company, Schenectady, NY (US)

(21) Appl. No.: 14/080,800

(22) Filed: Nov. 15, 2013

(51) Int. Cl. H02M 7/5387; H02M 1/14

(52) U.S. Cl. CPC H02M 7/5387; H02M 1/14
USPC 363/132

(57) ABSTRACT

A power conversion system is presented. The power conversion system includes a power converter. The power converter includes at least two circuits, where each of the at least two circuits includes two or more phase legs, where each of the two or more phase legs includes at least two semiconductor switches. Also, the at least two circuits includes an interphase reactor configured to couple one of the two or more phase legs to at least one other phase leg in the two or more phase legs. Moreover, the power conversion system includes a controller configured to obtain a switching pattern for each of the at least two semiconductor switches of the at least two circuits and selectively switch each of the at least two semiconductor switches based on the obtained switching pattern to reduce a common mode signal in the power conversion system. Method for power conversion is also presented.

This invention was made with Government support under grant number DE-EE0005344 awarded by the Government. The Government has certain rights in this invention.

### BACKGROUND

Embodiments of the present disclosure generally relate to power conversion and more specifically to a power conversion system that includes a transformer-less inverter.

As will be appreciated, an inverter is employed to convert a direct current (DC) to an alternating current (AC). Traditionally, inverters include transformers for providing galvanic isolation between a DC side and an AC side in order to prevent transmission of DC faults from the DC side to the AC side. The use of transformers in the inverters not only results in an increased footprint of the inverters, but also increases cost and lowers power conversion efficiency of the inverters. In recent times, there have been increased attempts to eliminate shortcomings associated with the use of transformer. To that end, different transformer-less inverter topologies have been developed. The transformer-less topologies aid in reducing cost and size of the inverter. Further, transformer-less topology aids in improving the efficiency of the inverter.

Moreover, the inverter employs different modulation techniques such as unipolar pulse width modulation (PWM) and bipolar PWM for effective power conversion. Although the unipolar PWM enables generation of a three-level voltage at the inverter output, a high frequency common mode voltage signal is also generated. The high frequency common mode voltage signal disadvantageously results in a high leakage current. Also, the high frequency common mode voltage signals result in complications due to electromagnetic interference (EMI). Unfortunately, the high leakage currents in the inverters using unipolar PWM render these inverters less suitable for transformer-less inverter applications.

Furthermore, use of bipolar PWM in the inverters results in a reduction of the common mode signal. Accordingly, the leakage current introduced in the system is minimal. However, inverters with bipolar PWM typically generate a two-level voltage output, thereby calling for the use of a filter having high inductance value. Accordingly, the efficiency of these inverters is diminished. Also, the size and the cost of the inverter increases.

### BRIEF DESCRIPTION

In accordance with aspects of the present disclosure, a power conversion system is presented. The power conversion system includes a power converter. The power converter includes at least two circuits, where each of the at least two circuits includes two or more phase legs, where each of the two or more phase legs includes at least two semiconductor switches. Also, the at least two circuits includes an interphase reactor configured to operatively couple one of the two or more phase legs to at least one other phase leg in the two or more phase legs. Moreover, the power conversion system includes a controller configured to obtain a switching pattern for each of the at least two semiconductor switches corresponding to the at least two circuits. Furthermore, the controller is configured to selectively switch each of the at least two semiconductor switches based on the obtained switching pattern to reduce a common mode signal in the power conversion system.

In accordance with another aspect of the present disclosure, a method for power conversion is presented. The method includes coupling at least two circuits, where the at least two circuits include two or more phase legs operatively coupled via an interphase reactor, where each of the two or more phase legs includes at least two semiconductor switches. Further, the method includes obtaining a switching pattern for each of the at least two semiconductor switches in each of the two or more phase legs using a controller. Additionally, the method includes selectively switching each of the at least two semiconductor switches in each of the two or more phase legs based on the obtained switching pattern to reduce a common mode signal in a power conversion system.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of an exemplary power conversion system, according to aspects of the present disclosure;

FIG. 2 is a diagrammatical representation of an exemplary embodiment of a power converter for use in the system of FIG. 1, according to aspects of the present disclosure;

FIG. 3 is a diagrammatical representation of another exemplary embodiment of a power converter for use in the system of FIG. 1, according to aspects of the present disclosure;

FIG. 4 is a flow chart representing an exemplary method for power conversion, according to aspects of the present disclosure;

FIG. 5 is a diagrammatical representation of a portion of the system of FIG. 1, according to aspects of the present disclosure;

FIG. 6 is a diagrammatical representation of waveforms generated by the power converter of FIG. 2, according to aspects of the present disclosure; and

FIG. 7 is a diagrammatical representation of an output waveform generated by the power converter of FIG. 2, according to aspects of the present disclosure.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit” and “circuitry” and “controller” may include either a single component or a plurality of components, which are either active and/or passive and are connected or otherwise coupled together to provide the described function.

As will be described in detail hereinafter, various embodiments of an exemplary system and method for power conversion are presented. By employing the system and the method for power conversion described hereinafter, a converter of reduced size and cost is provided. The term converter, as used herein, is used to refer to an inverter which converts one form of input voltage/current to another form of output voltage/current, where the inverter is of reduced size and cost, and devoid of a transformer. Particularly, the exemplary converter includes an inverter having a reduced size which converts a direct current to an alternating current. More specifically, the exemplary configuration provides a transformer-less inverter with improved conversion efficiency.

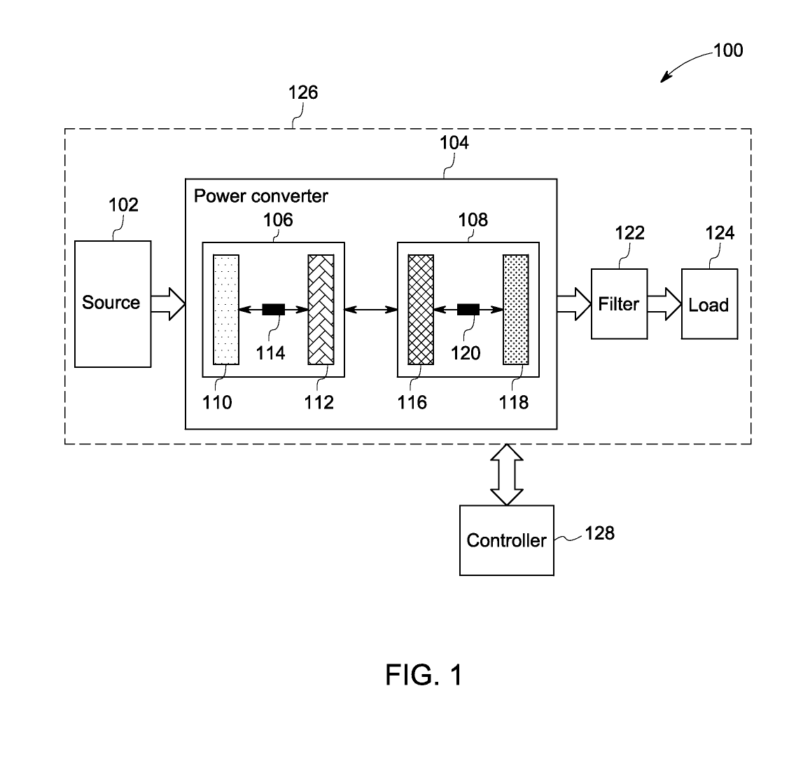

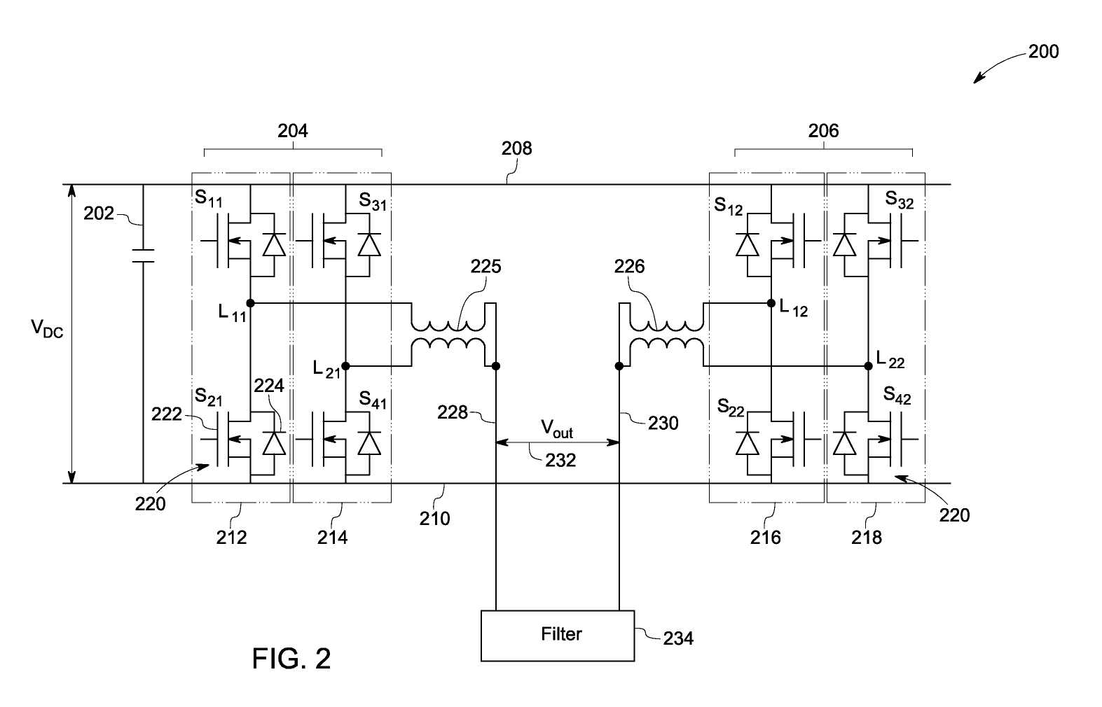

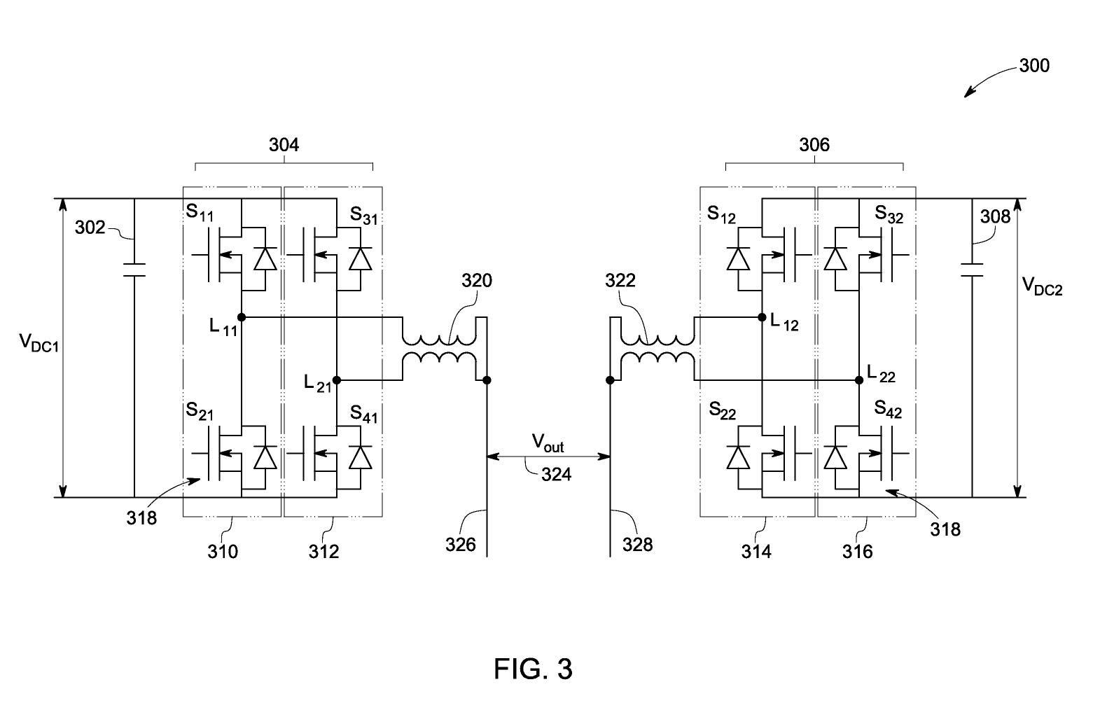

Turning now to the drawings, by way of example in FIG. 1, a power conversion system 100 is represented. In one embodiment, the power conversion system 100 may include a source 102 operatively coupled to a power converter 104. In one non-limiting example, the source 102 may include a direct current source. The direct current source may include a photovoltaic panel, a fuel cell, a battery, and the like. The power converter 104 may include at least two circuits. In one embodiment, the power converter 104 may include a first circuit 106 operatively coupled to a second circuit 108. The term operatively coupled, as used herein, may include wired coupling, electrical coupling, magnetic coupling, and the like. Also, in one embodiment, the first circuit 106 and the second circuit 108 may have substantially similar configurations. The topology of power converter 104 will be explained in greater detail with respect to FIGS. 2 and 3.

Moreover, each of the at least two circuits 106, 108 may include two or more phase legs. Also, an interphase reactor may be configured to operatively couple one of the two or more phase legs to at least one other phase leg in the two or more phase legs in each of the at least two circuits 106, 108. The term interphase reactor, as used herein, may be used to refer to a current equalizing reactor operatively coupled between two circuits or two or more phase legs and providing balanced operation of the power converter by acting as an inductive voltage divider when the circuits or the phase legs are conducting. Particularly, the interphase reactor may be configured provide an average output voltage based on the outputs of circuits 106, 108. Also, the interphase reactor may be configured to provide an equal average current in the two circuits 106, 108 or two or more phase legs.

In a presently contemplated configuration, the first circuit 106 may include a first phase leg 110 operatively coupled to a second phase leg 112 via an interphase reactor 114. Further, the second circuit 108 may also include a first phase leg 116 operatively coupled to a second phase leg 118 via an interphase reactor 120. Also, the interphase reactors 114, 120 may be configured to control a current circulating between the two or more phase legs in each of the first and second circuits 106, 108. By way of example, in the first circuit 106, the interphase reactor 114 may limit the flow of the current circulating between the first phase leg 110 and the second phase leg 112. In a similar manner, in the second circuit 108, the interphase reactor 120 may limit the current circulating between the first phase leg 116 and the second phase leg 118. The current circulating between the two or more phase legs in each of the first and second circuits 106, 108 may be representative of undesirable currents.

Also, according to the aspects of the present disclosure, each of the two or more phase legs 110, 112, 116, 118 may include at least two semiconductor switches. Additionally, the power converter 104 may be operatively coupled to a filter 122. The filter 122 may be configured to minimize ripples in an output parameter. The term output parameter, as used herein, may be used to refer to an output generated by the power converter 104. In one non-limiting example, the output parameter may include a current, a voltage, or a combination thereof. Furthermore, in one embodiment, the output parameter may include a three-level voltage. Also, in another example, the output parameter may be a variable quantity. The output parameter generated by the power converter 104 may be provided to a load 124. In one example, the load 124 may include a grid, an electrical appliance, a motor, and the like.

Moreover, for the ease of representation, the source 102, the power converter 104, and the load 124 may be depicted as a single unit 126. It may be noted that the system of FIG. 1 may also include a controller 128 operatively coupled to the unit 126. In one embodiment, the controller 128 may include a phase locked loop (PLL) based control system. The controller 128 may be configured to control the operation of the power converter 104, in one embodiment. Further, the controller 128 may be configured to obtain a switching pattern corresponding to each of the at least two semiconductor switches corresponding to the two or more phase legs of the first and second circuits 106, 108. In one example, the controller 128 may be configured to determine a switching pattern corresponding to each semiconductor switch in the two or more phase legs of the first and second circuits 106, 108 in real time. In another example, the controller 128 may be configured to acquire previously stored switching patterns corresponding to the semiconductor switches. In one embodiment, the controller 128 may be configured to determine the switching pattern of each of the at least two semiconductor switches based on a pulse width modulation (PWM) technique. Furthermore, the controller 128 may be configured to selectively switch each of the at least two semiconductor switches based on the obtained switching pattern to reduce a common mode signal in the power conversion system 100. In one example, the common mode signal may be a voltage. Additionally, the power converter 104 may be configured to generate the output parameter based on the selective switching of each of the at least two semiconductor switches of the power converter 104.

Additionally, in one example, the controller 128 may include an output parameter regulator (not shown). The controller 128 and more specifically, the output parameter regulator may be configured to regulate an amplitude and/or phase of the output parameter of the power converter 104. The output parameter regulator may include a current regulator, a voltage regulator, and the like.

As will be appreciated, power may be provided from the power converter 104 to the load 124. This power may generally be referred to as “real” power. Moreover, in one example, the controller 128 may include a current regulator configured to modify the phase of an output current of the power converter 104. Accordingly, the output current may lead or lag an output voltage of the power converter 104. As a result of the output current leading or lagging the output voltage, a reactive power may also be provided to the load 124 in addition to the real power. In one example, the reactive power may include a capacitive power or an inductive power.

Moreover, the controller 128 may also be configured to determine a load demand. In one non-limiting example, the term load demand may be used to refer to a full load condition, a no load condition, a partial load condition, a low load condition, and the like. In one example, in accordance with aspects of the present disclosure, the controller 128 may be configured to determine the switching pattern of the semiconductor switches based on the load demand. Accordingly, the first circuit 106 and/or the second circuit 108 may be selectively activated and deactivated based on the load demand. By way of example, during the low load condition, the controller 128 may be configured to selectively activate and deactivate the first circuit 106 and the second circuit 108. Particularly, during the low load condition, either the first circuit 106 or the second circuit 108 may be activated at a given instant of time. In one non-limiting example, the activation of a first circuit 106 may refer to activation of at least one of the at least two semiconductor switches corresponding to the first circuit 106. Also, in another example, at a given instant of time, the at least two semiconductor switches of either the first circuit 106 or the second circuit 108 may be activated. Accordingly, during the low load condition, switching losses of the power converter 104 may be reduced, thereby resulting in improved efficiency of the power converter 104. This mode of operation may also be referred to as ‘team operation.’ In an alternative embodiment, the team operation may include activating or deactivating the semiconductor switches of only one of the two or more phase legs of each of the at least two circuits based on the determined load demand.

Referring now to FIG. 2, a diagrammatical representation 200 of an exemplary embodiment of a power converter, such as the power converter 104 of FIG. 1, is depicted. A direct current (DC) source may be operatively coupled to the power converter 200 via a direct current link 202. The voltage provided by the DC source may be represented as V_{DC}. Furthermore, the power converter 200 may include a first circuit 204 operatively coupled via a first bus 208 and a second bus 210 to a second circuit 206. In one non-limiting example, the first bus 208 may include a positive DC bus and the second bus 210 may include a negative DC bus. In another example, the first bus 208 may include a positive DC voltage bus and the second bus 210 may include a negative DC voltage bus. In a presently contemplated configuration, the first circuit 204 and the second circuit 206 may be operatively coupled to the same DC link 202. Also, in one example, the first circuit 204 and the second circuit 206 may include an H-bridge circuit configuration.

In addition, the first circuit 204 may include a first phase leg 212 and a second phase leg 214. Moreover, the second circuit 206 may include a first phase leg 216 and a second phase leg 218. The first phase legs 212, 216 and the second phase legs 214, 218 corresponding to the first and second circuits 204, 206 may include at least two semiconductor switches 220. The semiconductor switches 220 may include an insulated gate bipolar transistor, a metal oxide semiconductor field effect transistor (MOSFET), a field effect transistor, an injection enhanced gate transistor, an integrated gate commutated thyristor, or combinations thereof. Alternatively, the semiconductor switches 220 may include a gallium arsenide based switch, a gallium nitride based switch, a silicon carbide based switch, and the like. The semiconductor switches 220 may also include a power diode. In a presently contemplated configuration, each semiconductor switch 220 may include a MOSFET coupled to an antiparallel power diode. In one non-limiting example, each semiconductor switch 220 may include a MOSFET with a parasitic body diode and/or a discrete diode. The parasitic body diode, the discrete diode, or the power diode provides an alternative path for a current flowing through the semiconductor switch 220. For ease of representation, the semiconductor switches 220 may be represented as S₁₁, S₂₁, S₃₁, S₄₁, S₁₂, S₂₂, S₃₂, and S₄₂.

In the first circuit 204, the first phase leg 212 may be operatively coupled to the second phase leg 214 using an interphase reactor 225. Particularly, a node L₁₁ of the first phase leg 212 may be operatively coupled to a node L₂₁ of the second phase leg 214 via the interphase reactor 225. An output terminal 228 may be formed by coupling the node L₁₁ and the node L₂₁ via the interphase reactor 225.

Similarly, in the second circuit 206, the first phase leg 216 may be operatively coupled to the second phase leg 218 via an interphase reactor 226. Specifically, a node L₁₂ of first phase leg 216 may be operatively coupled to a node L₂₂ of the second phase leg 218 via the interphase reactor 226. Also, an output terminal 230 may be formed by coupling the node L₁₂ and the node L₂₂ via the interphase reactor 226. In one example, design of the interphase reactors 225, 226 may be determined based on switching frequency. The term switching frequency, as used herein, may be used to refer to a frequency at which the semiconductor switches 220 may be activated and/or deactivated. An output voltage Vₒᵤₜ of the power converter 200 may be obtained across the output terminals 228 and 230. The output voltage Vₒᵤₜ may be represented by reference numeral 232. In a presently contemplated configuration, the output voltage Vₒᵤₜ may include a three-level voltage.

As previously noted, the current circulating between two or more phase legs in each of the at least two circuits is an undesirable current. The interphase reactor 225 may be configured to limit a current circulating between the first phase leg 212 and the second phase leg 214 corresponding to the first circuit 204. In a similar fashion, the interphase reactor 226 may be configured to limit the current circulating between the first phase leg 216 and the second phase leg 218 corresponding to the second circuit 206. In one embodiment, the generation of the current circulating in the first circuit 204 and the second circuit 206 may be minimized by controlling the switching of the semiconductor switches corresponding to the first circuit 204 and the second circuit 206, respectively. In one example, the current circulating in the first circuit 204 may be minimized by activating the semiconductor switch S₁₁ and the semiconductor switch S₄₁ at substantially similar instants of time.

In addition, when an interphase reactor is coupled between the first and second phase legs, a high impedance path is provided between the first and second phase legs. Accordingly, in FIG. 2, the current flowing between the first and second phase legs corresponding to the first and second circuits 204, 206 encounter higher impedance. Therefore, the current circulating between the first and second phase legs corresponding to the first and second circuits 204, 206 are reduced.

Furthermore, it may be noted that the size and/or inductance of the interphase reactors 225, 226 are dependent on a threshold value of the current circulating between the first and second phase legs corresponding to the first and second circuits 204, 206. The inductance of the interphase reactors 225, 226 decreases with the increase in the threshold value of the current circulating between the first and second phase legs corresponding to the first and second circuits 204, 206, in one example. Alternatively, the size and/or inductance of the interphase reactors 225, 226 may be dependent on a maximum voltage-second applied between nodes corresponding to the first and second phase legs corresponding to the first and second circuits 204, 206. By way of example, the inductance of the interphase reactors 225, 226 may be higher when the voltage-second between two nodes coupling the interphase reactor is higher. In the example of FIG. 2, the size of the interphase reactor 225 may be determined based on the maximum voltage-second between the nodes L₁₁ and L₂₁ corresponding to the first circuit 204. Similarly, the size of the interphase reactor 226 may be determined based on the maximum voltage-second between the nodes L₁₂ and L₂₂ corresponding to the second circuit 206. Also, the size and/or inductance of the interphase reactors 225, 226 may be determined such that the flow of current circulating between the first and second phase legs corresponding to the first and second circuits 204, 206 are reduced. In one example, the size and/or inductance of the interphase reactors 225, 226 may be determined such that the values of the current circulating between the first and the second phase legs corresponding to the first and second circuits are below a desired value.

With continuing reference to FIG. 2, the power converter 200 may include a filter 234, configured to filter ripples from an output parameter of the power converter 200. It may be noted that the filter 234 may include an inductor. Additionally, it may be noted that a mutual inductance of the interphase reactors 225, 226, leakage inductance due to the interphase reactors 225, 226, or a self-inductance of the interphase reactors 225, 226 may result in enhancing an inductance value of the inductor of the filter 234. This enhanced inductance value of the inductor aids in reducing the size of the inductor used in the filter 234, which in turn results in a reduced size of the filter 234. Accordingly, the size of the power conversion system, such as the power conversion system 100 of FIG. 1, may be reduced.

As noted hereinabove, a controller, such as the controller 128 of FIG. 1, is configured to obtain a switching pattern of the semiconductor switches 220 in each of the first and second circuits 204, 206. In one example, the controller may be configured to determine a switching pattern corresponding to the semiconductor switches 220 in each of the first and second circuits 204, 206 in real time. Particularly, the controller may be configured to determine the switching pattern of the semiconductor switches 220 based on a pulse width modulation (PWM) technique. In another example, the controller may be configured to acquire previously stored switching patterns corresponding to the semiconductor switches 220. Furthermore, the controller may be configured to selectively switch the semiconductor switches 220 in each of the first and second circuits 204, 206 based on the switching pattern. For example, the switching pattern corresponding to the semiconductor switches 220 of the first circuit 204 may be such that the switch S₁₁ may be activated when the switch S₂₁ is in a deactivated condition and vice versa. Similarly, the switch S₃₁ may be activated when the switch S₄₁ is in a deactivated condition and vice versa. In a similar manner, the switching pattern of the semiconductor switches in the second circuit 206 may determine the activation and/or deactivation of the semiconductor switches 220 corresponding to the second circuit 206. In addition, a desired output parameter of the power converter 200 may be obtained across the output terminals 228, 230 based on the selective switching of each of the semiconductor switches 220 corresponding to the first and second circuits 204, 206.

As previously noted, during low load conditions, the controller may be configured to selectively activate semiconductor switches corresponding to either the first circuit 204 or the second circuit 206 at a given instant of time, thereby minimizing the switching losses. Alternatively, to curtail the switching losses during low load conditions, the controller may be configured to activate semiconductor switches 220 of either the first or second phase legs of the first and second circuits 204, 206. In addition, the controller may be configured to regulate an amplitude and phase of the output parameter of the power converter 200. In one example, the regulation of the phase of the output parameter of the power converter 200 may aid in controlling the power provided to a load, such as the load 124 of FIG. 1.

Also, the semiconductor switches of the first circuit 204 and the second circuit 206 may be switched by employing a pulse width modulation technique. This technique of pulse width modulation may also be referred to as an interleaved bipolar PWM. Specifically, the term ‘interleaved bipolar PWM’, as used herein, may be used to refer to the pulse width modulation of at least two circuits operatively coupled to each other by employing phase shifted carrier waves having substantially similar carrier PWM frequencies. By way of example, the PWM in the first circuit 204 may be achieved by employing a constant frequency carrier wave phase shifted by about 180 degrees. Furthermore, the PWM in the second circuit 206 may be achieved via use of a constant frequency carrier wave without a phase shift. Accordingly, in one embodiment, the semiconductor switches of the first circuit 204 and the second circuit 206 may be switched at a phase shift of about 180 degrees. In addition, the semiconductor switches of the first and second circuits 204, 206 may be switched at substantially similar frequencies. In one embodiment, the semiconductor switches of the first and second circuits 204, 206 may be switched at the same frequency.

In an alternative embodiment, the second circuit 206 may use a carrier wave of constant frequency shifted by about 180 degrees for modulation, while the first circuit 204 may employ a constant frequency carrier wave without phase shift for modulation. By employing the interleaved bipolar PWM a three-level output voltage may be generated across the output terminals 228 and 230. Furthermore, use of the interleaved bipolar PWM results in a desirable pattern of switching of the switches 220 of the first and second circuits 204, 206. This pattern of switching aids in minimizing a common mode signal. As a result, the leakage current in the power converter 200 may be reduced. Also, the ripples in the output voltage 232 may be minimized.

Moreover, in accordance with aspects of the present disclosure, the PWM of the power converter 200 employs a modulation index having a positive value and a negative value. By employing a modulation index having a positive and a negative value, a three level output voltage may be generated at the output of the power converter 200. In one non-limiting example, the modulation index varies from +0.3 to −0.3. The term modulation index, as used herein, may be used to refer to a measure of a variation surrounding an unmodulated carrier wave. The generation of the three-level output voltage will be explained in greater detail with reference to FIG. 7. The three-level output voltage aids in minimizing ripples in the output generated by the power converter 200. Consequently, a filter of a lower inductance value may be employed at the output of the power converter 200, thereby allowing use of a filter of a relatively smaller size. In one embodiment, a frequency of an output voltage of the power converter may be equivalent to double the frequency of the carrier wave.

FIG. 3 is a diagrammatical representation 300 of another exemplary embodiment of a power converter for use in the system of FIG. 1, according to aspects of the present disclosure. In the example of FIG. 3, the power converter 300 may be operatively coupled to two DC links. The two DC links may be represented by reference numerals 302 and 308. The power converter 300 may include a first circuit 304 operatively coupled to the first DC link 302. Furthermore, the power converter 300 may include a second circuit 306 operatively coupled to the second DC link 308. Also, a DC voltage across the first DC link 302 may be represented as V_{DC1} and the DC voltage across the second DC link 308 may be represented as V_{DC2}. The first circuit 304 may include a first phase leg 310 and a second phase leg 312. Moreover, the second circuit 306 may include a first phase leg 314 and a second phase leg 316. Furthermore, the first and second circuits 304, 306 may include at least two semiconductor switches 318 in each of the first and second phase legs 310, 312, 314, 316.

It may be noted that in the first circuit 304, the first phase leg 310 may be operatively coupled to the second phase leg 312 via an interphase reactor 320. In a similar manner, in the second circuit 306, the first phase leg 314 may be operatively coupled to the second phase leg 316 using an interphase reactor 322. Also, the output voltage (Vₒᵤₜ) 324 of the power converter 300 may be obtained across output terminals 326, 328. Although the examples of FIGS. 2 and 3 represent power converter configurations employing two circuits and having two output terminals, use of power converter configurations having more than two circuits and more than two output terminals is also envisaged.

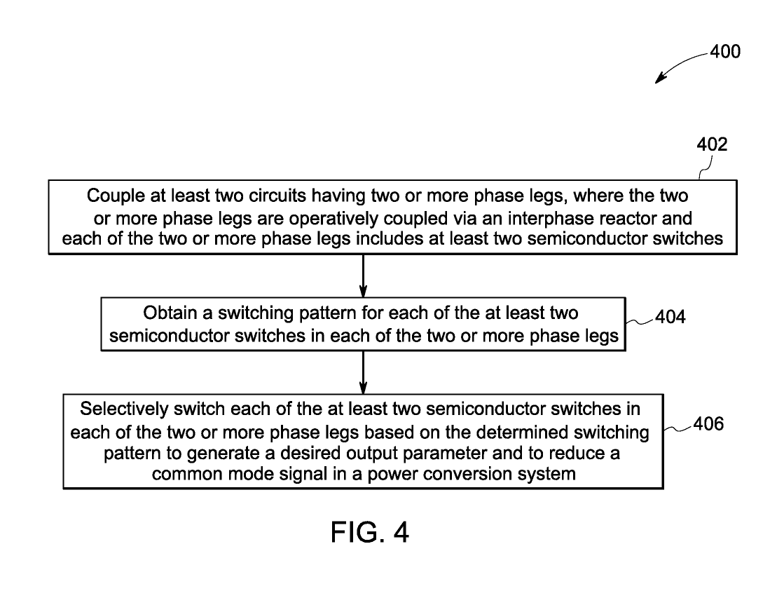

Turning now to FIG. 4, a flow chart 400 representing an exemplary method for converting power, according to aspects of the present disclosure, is depicted. For ease of understanding, the method of FIG. 4 will be described with respect to the elements of FIG. 2. The method begins at step 402, where at least two circuits having two or more phase legs are operatively coupled. As noted hereinabove, the first circuit 204 may include a first phase leg 212 and a second phase leg 214. Also, the second circuit 206 may include a first phase leg 216 and a second phase leg 218. Also, each of the first and second phase legs 212, 214, 216, 218 may include at least two semiconductor switches 220. Moreover, the two or more phase legs corresponding to each of the at least two circuits may be operatively coupled via an interphase reactor. Furthermore, the first circuit 204 may be operatively coupled to the second circuit 206 via a first bus 208 and a second bus 210.

Furthermore, at step 404, a switching pattern for each of the at least two semiconductor switches in each of the two or more phase legs may be obtained. In one example, obtaining the switching pattern for each semiconductor switch 220 may include determining a switching pattern corresponding to each semiconductor switch 220 in the two or more phase legs in real time. In another example, obtaining the switching pattern for each semiconductor switch 220 may include acquiring previously stored switching patterns corresponding to each semiconductor switch 220. Moreover, the switching pattern for the semiconductor switches 220 of the first phase legs 212, 214 and the second phase legs 216, 218 of the first and second circuits 204, 206 may be determined based on a pulse width modulation technique. As previously noted, an interleaved bipolar PWM may be employed. Also, the switching pattern for the semiconductor switches may be determined based on a load demand. As noted hereinabove, the term load demand may refer to a full load condition, a no load condition, a partial load condition, a low load condition, and the like.

Also, at step 406, each of the at least two semiconductor switches in each of the two or more phase legs may be selectively switched based on the determined switching pattern to reduce a common mode signal in a power conversion system, such as the power conversion system 100 of FIG. 1. Additionally, a desired output parameter may be generated at output terminals of the power converter 200 based on the selective switching of each of the at least two semiconductor switches. The semiconductor switches 220 in the first phase legs 212, 214 and second phase legs 216, 218 may be selectively switched based on the switching pattern determined at step 404. In one example, selective switching of the semiconductor switches 220 may include activation and/or deactivation of the semiconductor switches 220. A gating signal may be provided such that each of the semiconductor switches 220 is activated and/or deactivated in accordance with the determined switching pattern. For example, the gating signals may be provided in such a manner that semiconductor switches S₁₁ and S₄₁ are actuated at substantially similar instants in time. Also, in one example, the gating signals may be provided in such a manner that both the switches in a phase leg are not activated at the same instant of time in order to avoid a short circuit condition. Accordingly, in one example, while the semiconductor switch S₁₁ is activated, the semiconductor switch S₂₁ is in a deactivated condition.

Additionally, as previously noted, the selectively switching of semiconductor switches 220 may include activating and deactivating the semiconductor switches 220 corresponding to the first and second circuits 204, 206 at substantially similar frequencies. Alternatively, in certain other embodiments, the selectively switching of the semiconductor switches 220 may include activating and deactivating the semiconductor switches 220 corresponding to the first and second circuits 204, 206 at phase-shifted frequencies.

Moreover, as noted hereinabove, at step 406, the selectively switching of the at least two semiconductor switches 220 may aid in reducing a common mode signal in the power conversion system. In one non-limiting example, the common mode signal may have a substantially low value. Also, in another example, the common mode signal may be a constant value. In a presently contemplated configuration, although a transformer is not employed for isolating a source, such as the source 102 of FIG. 1 and a load, such as the load 124 of FIG. 1, the selective switching of semiconductor switches 220 in the first and second phase legs 212, 214, 216, 218 may aid in reducing the common mode signal in the power conversion system.

Also, as previously noted, the amplitude and phase of the output parameter may be regulated. In one example, a controller, such as the controller 128 of FIG. 1, may be employed to regulate the amplitude and/or phase of the output parameter. More specifically, the amplitude and the phase of the current across the output terminals 228, 230 may be regulated by a current regulator in the controller. By regulating the phase of the current, the current may lead or lag the voltage across the output terminals 228, 230. Generally, real power is fed to the load from the power converter 200. As a result of the current leading or lagging the voltage, reactive power may also be provided to the load in addition to the real power.

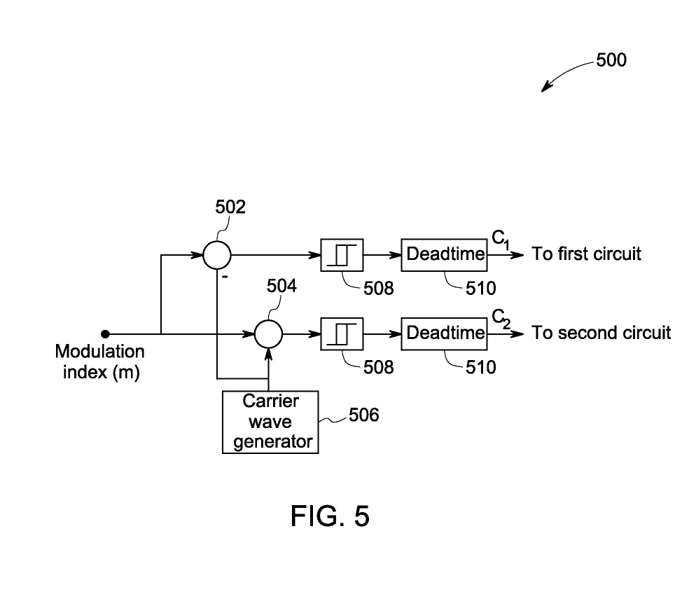

FIG. 5 represents a diagrammatical representation 500 of a portion of the system of FIG. 1, according to aspects of the present disclosure. Specifically, FIG. 5 represents a portion of the system of FIG. 1 configured to generate carrier waves at a phase difference of about 180 degrees for pulse width modulation in the power converter, such as the power converter 200 of FIG. 2. For ease of understanding, FIG. 5 will be explained with respect to the elements of FIG. 2. Reference numerals 502 and 504 represent a mixer for combining a modulation index and a carrier wave. As noted hereinabove, the modulation index is a measure of a variation surrounding an un-modulated carrier wave. In one non-limiting example, the modulation index varies from +0.3 to −0.3. The constant frequency carrier wave is generated by a carrier wave generator 506. In the example of FIG. 5, the constant frequency (f) carrier wave is phase shifted and delivered to a first circuit, such as the first circuit 204 of FIG. 2. In one example, the constant frequency carrier wave may be phase shifted by 180 degrees. The phase shifted carrier wave may be represented as C₁. The constant frequency carrier wave without phase shift may be provided to a second circuit, such as the second circuit 206 of FIG. 2. The carrier wave without phase shift may be represented as C₂. Moreover, reference numeral 508 may be representative of a hysteresis block and reference numeral 510 may be representative of a dead time block. The hysteresis block 508 and the dead time block 510 may be configured to control certain parameters associated with the carrier waves C₁ and C₂. In one example, the parameters associated with the carrier waves C₁, C₂ may include an amplitude, a time period, and the like.

As noted hereinabove, the semiconductor switches of the first circuit 204 and the second circuit 206 may be switched by employing a pulse width modulation technique. Specifically, the pulse width modulation (PWM) in the first circuit 204 may be achieved by employing the constant frequency carrier wave phase shifted by about 180 degrees (C₁). Furthermore, PWM in the second circuit 206 may be achieved by the constant frequency carrier wave without a phase shift (C₂). In an alternative embodiment, the second circuit 206 may use a carrier wave C₁ of constant frequency phase shifted by about 180 degrees for modulation, while the first circuit 204 employs a constant frequency carrier wave C₂ without phase shift for modulation. In addition, the semiconductor switches of the first and second circuits 204, 206 may be switched at substantially similar frequencies. In one embodiment, the semiconductor switches of the first and the second circuits 204, 206 may be switched at the same frequency.

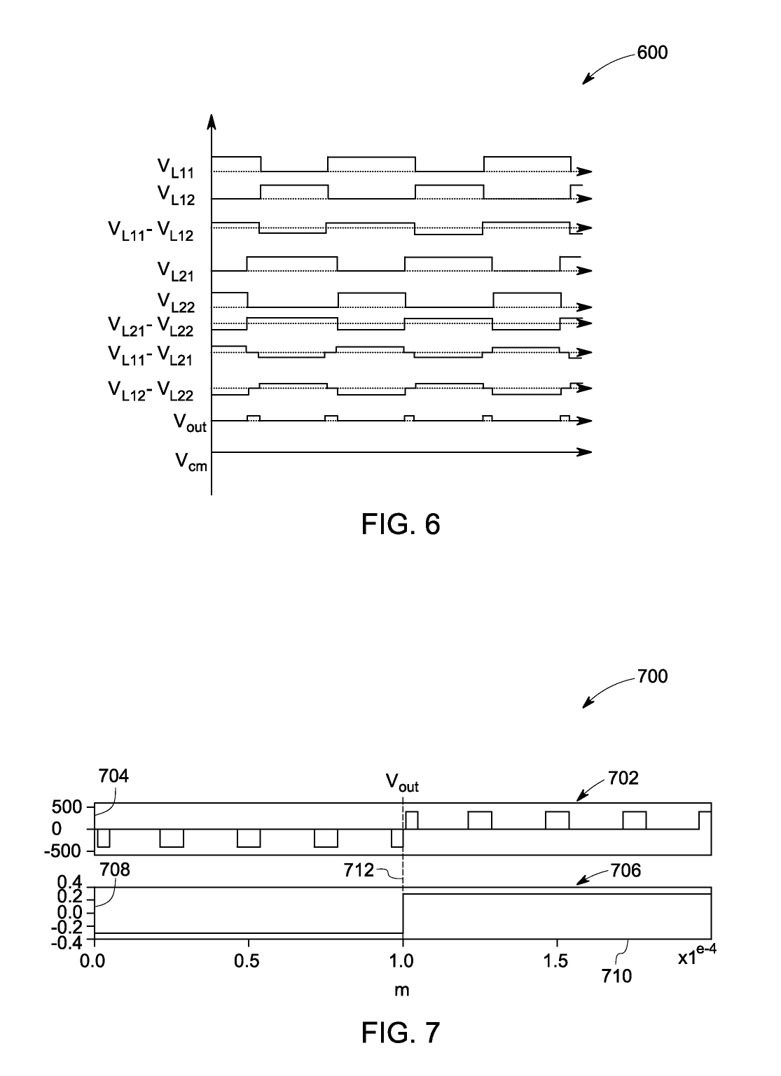

Referring now to FIG. 6, a diagrammatical representation 600 of waveforms corresponding to the power converter of FIG. 2, according to aspects of the present disclosure, is depicted. More specifically, FIG. 6 represents the waveforms corresponding to an interleaved bipolar PWM technique used in the power converter of FIG. 2. For ease of understanding, the waveforms of FIG. 6 will be explained with respect to the elements of FIG. 2. As noted hereinabove with respect to FIG. 5, the carrier waveforms C₁ and C₂ are generated at a phase difference of about 180 degrees. Also, in one non-limiting example, the first circuit 204 may be configured to employ the carrier waveform C₁, while the second circuit 206 may be configured to employ the carrier waveform C₂, for pulse width modulation. Accordingly, the switches S₁₁, S₁₂, S₂₁, S₂₂, S₃₁, S₃₂, S₄₁, and S₄₂ may be selectively activated and deactivated to generate voltage signals at nodes L₁₁, L₁₂, L₂₁, and L₂₂. The voltage at the nodes L₁₁, L₁₂, L₂₁, and L₂₂ may be representative of the voltage at the respective nodes of each of the first and second phase legs 212, 214, 216, 218, with respect to the second bus 210. Voltage signals corresponding to the nodes L₁₁, L₁₂, L₂₁, and L₂₂ are depicted as waveforms V_{L11}, V_{L12}, V_{L21}, and V_{L22} in FIG. 6.

Moreover, in one example, a common mode voltage signal may correspond to an instantaneous summation of the voltages at the nodes L₁₁, L₁₂, L₂₁, and L₂₂. In one non-limiting example, the common mode voltage signal (V_{cm}) may be represented as (V_{L11}+V_{L12}+V_{L21}+V_{L22})/4, where V_{L11}, V_{L12}, V_{L21}, and V_{L22} may be obtained at a given instant of time. As depicted in FIG. 6, by employing the interleaved bipolar PWM, the common mode signal V_{cm}, may have a substantially low and/or a constant value. As previously noted, the term interleaved bipolar PWM, is used to refer to the pulse width modulation of at least two circuits operatively coupled to each other by employing phase shifted carrier waves having substantially similar carrier PWM frequencies.

Also, the voltages represented by V_{L11}-V_{L21} may correspond to a voltage across the first phase leg 212 and the second phase leg 214 of the first circuit 204. In particular, V_{L11}-V_{L21} represents the voltage across the interphase reactor 225. The voltage represented by V_{L12}-V_{L22} may correspond to a voltage across the first phase leg 216 and the second phase leg 218 of the second circuit 206. In particular, V_{L12}-V_{L22} represents the voltage across the interphase reactor 226.

Additionally, voltage V_{L11}-V_{L12}, may be representative of the voltage across the first phase leg 212 of the first circuit 204 and the first phase leg 216 of the second circuit 206, while the voltage V_{L21}-V_{L22} may be representative of a voltage across the second phase leg 214 of the first circuit 204 and the second phase leg 218 of the second circuit 206. The output voltage 232 of the power converter 200 across the output terminals 228, 230 of FIG. 2 may be represented as Vₒᵤₜ. In one example, the output voltage Vₒᵤₜ may be represented as [(V_{L11}-V_{L12})/2+(V_{L21}-V_{L22})/2].

Moreover, in a presently contemplated configuration of the power converter 200 that uses interleaved bipolar PWM, a modulation index with a positive value and a negative value may be employed. As noted hereinabove, the modulation index is a measure of a variation surrounding an un-modulated carrier wave. In the example of FIG. 6, the waveforms corresponding to the positive value of modulation index are depicted. Furthermore, in FIG. 6, only a portion of the three level output voltage Vₒᵤₜ generated across the output terminals 228, 230 of the power converter 200 is represented. Accordingly, in FIG. 6, the output voltage Vₒᵤₜ is depicted as having positive values and a zero value. The three level output voltage Vₒᵤₜ generated across the output terminals 228, 230 of the power converter 200 for positive and negative values of the modulation index is depicted in greater detail with respect to FIG. 7.

Turning now to FIG. 7, diagrammatical representation 700 of an output waveform generated by the power converter of FIG. 2, according to aspects of the present disclosure, is depicted. More specifically, FIG. 7 represents the three level output voltage waveform generated across the output terminals of the power converter, such as the power converter 200 of FIG. 2, for positive and negative values of the modulation index. For ease of understanding, the waveforms of FIG. 7 will be explained with respect to the elements of FIGS. 2 and 6. The three level voltage may include a positive value, a negative value, and a zero value. Reference numeral 702 represents the three level output voltage Vₒᵤₜ generated across the output terminals 228, 230 of the power converter 200. In the example of FIG. 7, the output voltage 702 may be represented with respect to time. Also, reference numeral 704 represents the amplitude of the output voltage. Further, reference numeral 706 represents a modulation index (m) with respect to time. Reference numeral 708 represents a value of the modulation index (m). In the example of FIG. 7, the modulation index (m) 706 may have values +0.3 and −0.3. Moreover, reference numeral 710 represents time in seconds.

In the example of FIG. 7, reference numeral 712 depicts a point where the modulation index changes from a negative value to a positive value. When the modulation index changes from the negative value to the positive value at point 712, the output voltage may change from a negative value to a non-negative value. The non-negative value of output voltage may include a zero value, a positive value, or a combination thereof. Also, in one example, when the modulation index has a positive value (+0.3), the output voltage 232 obtained across the output terminals 228, 230 may have positive values and a zero value. In the example of FIG. 7, the positive value of the output voltage 232 is +500 volts. However, when the modulation index has a negative value (−0.3), the output voltage 232 may have a negative value and a zero value. In the example of FIG. 7, the negative value of output voltage 232 is −500 volts. Therefore, a modulation technique employing a combination of positive and negative values of the modulation index aids in the generation of a three-level output voltage. This three-level output voltage may appear across the output terminals 228, 230 of the power converter 200.

Furthermore, the foregoing examples, demonstrations, and process steps such as those that may be performed by the system may be implemented by suitable code on a processor-based system, such as a general-purpose or special-purpose computer. It should also be noted that different implementations of the present disclosure may perform some or all of the steps described herein in different orders or substantially concurrently, that is, in parallel. Furthermore, the functions may be implemented in a variety of programming languages, including but not limited to C, C++ or Java. Such code may be stored or adapted for storage on one or more tangible, machine readable media, such as on data repository chips, local or remote hard disks, optical disks (that is, CDs or DVDs), memory or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

The various embodiments of the system and the methods for converting power described hereinabove aid in providing a transformer-less inverter, thereby allowing reduction in the size and/or cost of the power conversion system. Furthermore, the exemplary system and method for converting power and in minimizing the common mode voltage signals and ripples at the output terminal. Also, by employing the interleaved bipolar PWM technique, a three-level voltage is generated, thereby providing a power converter with enhanced conversion efficiency. The various embodiments of the transformer-less inverter may find application in solar, battery, fuel cells, and other renewable and non-renewable power generation systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

1. A power conversion system, comprising:
a power converter, comprising:
at least two circuits, wherein each of the at least two circuits comprises:
two or more phase legs, wherein each of the two or more phase legs comprises at least two semiconductor switches;
an interphase reactor configured to operatively couple one of the two or more phase legs to at least one other phase leg in the two or more phase legs;
a controller configured to:
obtain a switching pattern for each of the at least two semiconductor switches corresponding to the at least two circuits; and
selectively switch each of the at least two semiconductor switches based on the obtained switching pattern to reduce a common mode signal in the power conversion system.

2. The system of claim 1, wherein the at least two semiconductor switches in each of the two or more phase legs comprise an insulated gate bipolar transistor, a metal oxide semiconductor field effect transistor, a field effect transistor, an injection enhanced gate transistor, an integrated gate commutated thyristor, or combinations thereof.

3. The power converter of claim 1, wherein the at least two semiconductor switches in each of the two or more phase legs comprise a gallium arsenide based switch, a gallium nitride based switch, a silicon carbide based switch, or combinations thereof.

4. The system of claim 1, wherein the at least two semiconductor switches comprise a power diode, a parasitic body diode, a discrete diode, or combinations thereof.

5. The system of claim 1, further comprising at least one direct current source, at least one direct current link, a load, or combinations thereof.

6. The system of claim 5, wherein the at least one direct current source comprises a fuel cell, a photovoltaic panel, a battery, or combinations thereof.

7. The system of claim 5, wherein the load comprises a grid, an electrical motor, or a combination thereof.

8. The system of claim 5, wherein the controller is configured to obtain the switching pattern based on a load demand.

9. The system of claim 1, wherein the controller comprises a phase locked loop control circuit.

10. The system of claim 1, wherein the controller is configured to generate a desired output parameter based on the selective switching of the at least two semiconductor switches corresponding to each of the at least two circuits.

11. The system of claim 10, wherein the controller is further configured to regulate an amplitude of the output parameter, a phase of the output parameter, or a combination thereof.

12. The system of claim 10, wherein the output parameter comprises a voltage, a current, or a combination thereof.

13. The system of claim 10, wherein the output parameter comprises a three-level voltage.

14. The system of claim 10, further comprising a filter configured to minimize ripple in the output parameter.

15. The system of claim 1, wherein the interphase reactor is configured to control a current circulating between the two or more phase legs in each of the at least two circuits.

16. A method for power conversion, comprising:
coupling at least two circuits, wherein the at least two circuits comprise two or more phase legs operatively coupled via an interphase reactor, wherein each of the two or more phase legs comprises at least two semiconductor switches;
obtaining a switching pattern for each of the at least two semiconductor switches in each of the two or more phase legs using a controller; and
selectively switching each of the at least two semiconductor switches in each of the two or more phase legs based on the obtained switching pattern to reduce a common mode signal in a power conversion system.

17. The method of claim 16, further comprising generating a desired output parameter based on the selective switching of each of the at least two semiconductor switches in each of the two or more phase legs.

18. The method of claim 17, further comprising regulating an amplitude of the output parameter, a phase of the output parameter, or a combination thereof.

19. The method of claim 16, wherein selectively switching each of the at least two semiconductor switches comprises activating and deactivating each of the at least two semiconductor switches corresponding to each of the two or more phase legs at similar frequencies.

20. The method of claim 16, wherein selectively switching each of the at least two semiconductor switches comprises activating and deactivating each of the at least two semiconductor switches corresponding to each of the two or more phase legs at phase-shifted frequencies.

21. The method of claim 16, wherein obtaining the switching pattern comprises using an interleaved bipolar pulse width modulation technique.
